(19) United States
(12) Patent Application Publication
(10) Pub. No.: US 2010/0018953 A1
(43) Pub. Date: Jan. 28, 2010

(54) REUSABLE MANDREL FOR SOLID FREE FORM FABRICATION PROCESS

(76) Inventors: Vladimir Shapovalov, Albuquerque, NM (US); Roger S. Storm, Tucson, AZ (US); James C. Withers, Tucson, AZ (US); Raouf Loutfy, Tucson, AZ (US)

Correspondence Address: HAYES SOLOWAY P.C., 3450 E. SUNRISE DRIVE, SUITE 140, TUCSON, AZ, 85718, US

(21) Appl. No.: 12/503,576

(22) Filed: Jul. 15, 2009

Related U.S. Application Data
(60) Provisional application No. 61/083,148, filed on Jul. 23, 2008.

(51) Int. Cl. B23K 15/00; H05B 1/00; B23K 26/20

(52) U.S. Cl. 219/121.14; 219/160; 219/121.13; 219/121.63; 219/121.64

(57) ABSTRACT

The present invention provides a reusable mandrel and method of using the mandrel in a SFFF process. A thermally conductive feature is located on the surface of the mandrel. The mandrel does not bond to the deposited part so that it may be easily removed without damaging either the mandrel or the deposited part. The present invention further enables the manufacture of components where the deposition surface is produced to precision, net shape geometries.

### CROSS-REFERENCE TO RELATED APPLICATIONS

This application claims priority from U.S. provisional application Ser. No. 61/083,148 filed Jul. 23, 2008.

### FIELD OF THE INVENTION

The present invention relates to solid material fabrication, and more particularly relates to solid free form fabrication processes through feedstock deposition using an energy beam and advancing a molten puddle of rapidly solidifying material layered upon a substrate.

### BACKGROUND OF THE INVENTION

Solid free form fabrication (SFFF), also known as rapid additive manufacturing or rapid prototyping, is a method of producing 3-dimensional metal shapes using a high energy beam combined with a multi axis positioning system. The SFFF process involves supplying a metal feed, which can be a particulate form or wire, to a high energy beam, melting the metal feed with the high energy beam to form a small molten metal pool, and moving either the energy beam position or the part position or both so as to build up a 3-dimensional structure by depositing multiple layers without the use of tooling. The positioning system commonly employed is a multi axis CNC based system or a multi axis robot, both of which manipulate either the energy beams or the part position or both. The high energy beams employed commonly include laser or a welding torch such as an E-beam, plasma transferred arc (PTA), TIG or MIG. Since the deposited parts can be produced to near net shape, the SFFF process can produce complex components rapidly and at a lower cost than conventional metal manufacturing processes such as casting, forging or machining.

The SFFF process is initiated by depositing the molten metal feed onto a mandrel or substrate. This mandrel can be, e.g. the same metal composition as the deposited metal, a different metal composition, graphite, or a ceramic such as a nitride (including boron nitride and silicon nitride), carbide, oxide, or mixtures thereof. The high temperature of the molten metal pool, which is typically several hundred degrees Celsius above the melting point of the metal being deposited, results in some bonding of the first deposited layer to the mandrel. In the case of a metal mandrel, the deposit may be welded to the mandrel. The deposited metal also may form an alloy with the mandrel if they are of different compositions. In the case of graphite or a ceramic mandrel, the bonding can result from the formation of carbides, nitrides, oxides, etc. This process has been described numerous times in the literature including the international patent literature. One such example is Henn in U.S. Pat. No. 7,073,561, “Solid Freeform Fabrication System and Method”. Henn describes positioning an E-beam heat source over a mandrel and providing sufficient heat input to fuse the feedstock with the surrounding substrate material. He further states that when a metal is deposited within a mold, the deposit may be separated from the mold by disintegrating or dissolving the mold.

In some instances, the deposited part can be designed so that the mandrel becomes a part of the final geometry. However, in many applications, the mandrel subsequently must be removed to obtain the desired geometry for the deposited part, which typically involves machining, or possibly removal by chemical or thermal decomposition of the mandrel. Mandrel removal is required even if the bonding between the deposited metal and the mandrel is incomplete as well as when an interface reaction has occurred. Mandrel removal adds considerably to the manufacturing cost of the final component being produced. This is in addition to the cost of the non-reusable mandrel.

### SUMMARY OF THE INVENTION

The present invention improves upon SFFF processes such as described above by providing a mandrel, and method for using the mandrel, wherein the mandrel does not bond to the resulting structure. The structure easily may be removed without damaging either the mandrel or the structure, and the mandrel may be reused to make an identical or different structure.

Another advantage of the present invention is provided in that where the mandrel has a composition different from that of the feedstock material deposited on the mandrel, the mandrel does not alter or otherwise contaminate the composition of the deposited material as a result of the deposition process. This reusable mandrel enables the manufacture of components where the deposition surface is produced to precision, net shape geometries.

One aspect of the present invention provides a mandrel having a thermally conductive feature on its top surface, for use in connection with a SFFF process to form a structure by depositing a feedstock material onto the mandrel using a high energy beam. The thermally conductive feature on the top surface of the mandrel, provides a path for directing a heat flow away from the feedstock material as it is deposited in a molten form. This prevents the top surface of the mandrel from bonding with or contaminating the feedstock material. Further, the mandrel readily can be detached from the structure so as to be reusable. The thermally conductive feature has a tapered edge and may be formed by attaching the thermally conductive feature to the top surface of the mandrel or by forming the thermally conductive feature as an integral element of the mandrel, such as by machining or by deposition using SFFF.

Another aspect of the present invention provides a process for forming a structure using the mandrel described above. The SFFF process is initiated by depositing the feedstock material directly onto the thermally conductive feature of the mandrel to create a first deposit. The SFFF process may be carried out with a thin layer of discrete unmelted metal particles located on the top surface of the mandrel. Further, the SFFF process may be conducted such that a plurality of deposited layers are created wherein each successive deposited layer is only in direct contact with one of the previous deposited layers.

Yet another aspect of the present invention provides a method of producing thin, three-dimensional shapes using a SFFF process. The method includes providing a high energy beam capable of localized rapid heating, a first device capable of controlling movement in three dimensions, a second device capable of feeding a feedstock material to the high energy beam, and a mandrel having a desired geometry. The feedstock material is moved into the high energy beam to heat up the feedstock material, creating a pool of molten metal. The high energy beam is scanned over a surface of the mandrel to form a series of deposited layers, each deposited layer being formed from a pool of molten metal on the surface of the mandrel. The process is controlled by manipulating various attributes of the high energy beam, the first device, and/or the second device, in order to cause the series of deposited layers to bond to one another. The control of the process may be adjusted in view of a set of parameters that may be monitored to ensure that the result of the process is a three-dimensional structure having a desired net shape and mechanical properties. Upon forming the three-dimensional structure with a desired net shape (such as a shell, a tube, or a plate), the mandrel may be separated from the structure and reused. This method may be accomplished using a thermally conductive feature (as described above) in the form of a raised shape on the surface of the mandrel.

### BRIEF DESCRIPTION OF THE DRAWINGS

Further features and advantages of the present invention will be seen from the following detailed description, taken in conjunction with the accompanying drawings, wherein:

FIG. 1 is a side view of a first deposit being formed on the surface of a mandrel according to a solid free form fabrication (SFFF) process;

FIGS. 2a and 2b, are illustrations of a first deposit and a plurality of deposits, respectively, having been deposited on a mandrel as in FIG. 1;

FIG. 3 is a side view depicting the changing shape of a deposit on the surface of the mandrel;

FIG. 4a is a side view of a thermally conductive feature that attached to a mandrel in accordance with the present invention;

FIG. 4b is a side view of a thermally conductive feature having been formed integral to a mandrel in accordance with the present invention;

FIG. 4c is a side view of a thermally conductive feature that has been deposited on a mandrel using a SFFF process in accordance with the present invention;

FIG. 5a is a side view depicting a deposit being formed on the thermally conductive feature in accordance with the present invention;

FIG. 5b is a side view of successive deposits being formed in accordance with the present invention;

FIG. 6 is a side view depicting additional deposits being formed in accordance with the present invention;

FIG. 7 is a side view showing the heat flow being directed through previous deposits to the thermally conductive feature in accordance with the present invention;

FIGS. 8a, 8b, and 8c are side views depicting a series of steps for using a thermally conductive feature that is attached to the mandrel using a bolt, in accordance with the present invention; and

FIG. 9 is a side view of a structure being formed on a mandrel wherein discrete, unmelted metal particles are located on the surface of the mandrel in accordance with the present invention.

### DETAILED DESCRIPTION OF THE INVENTION

In the following description, reference is made to the accompanying drawings, which form a part hereof, and in which is shown, by way of illustration, various embodiments of the present invention. It is understood that other embodiments may be utilized and changes may be made without departing from the scope of the present invention.

The instant invention, in one aspect, provides a reusable mandrel or substrate for a solid free form fabrication process (SFFF) process that is readily detachable from the metal parts deposited on said mandrel, allowing said mandrel to be used for multiple depositions, without causing contamination of the deposited metal. This composition of the reusable mandrel can be e.g. the same metal as the metal being deposited, or a different metal, or graphite, or an inorganic or ceramic composition.

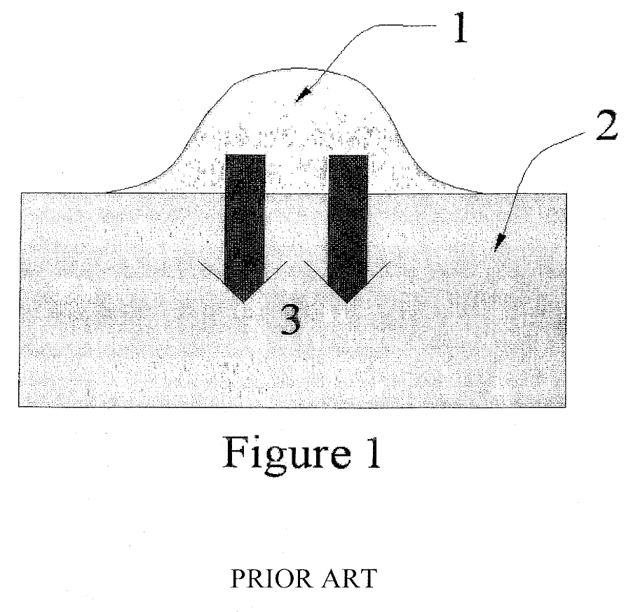

During the SFFF process, heat is conducted away from the molten pool of the deposited metal to the adjacent cooler surfaces, allowing the deposit to solidify. Referring to FIG. 1, during a typical SFFF deposition, the deposited molten metal (1) is applied directly to the surface of the mandrel (2). The heat flow (3) occurs directly from the molten metal pool to the adjacent mandrel as illustrated in FIG. 1. This causes the temperature of the mandrel to increase substantially and may cause melting of the surface of the mandrel, resulting in bonding of the deposit to the mandrel. This can occur even if the melting point of the mandrel is much higher than the melting point of the deposit. For very high melting point mandrel materials such as a ceramic or graphite, the molten deposited metal can react with the mandrel forming e.g. carbides, nitrides, and oxides, resulting in bonding between the deposited metal and the mandrel. A critical element of the instant invention is to provide a path for heat flow away from the molten pool of the deposited metal that avoids bonding between the deposit and the mandrel.

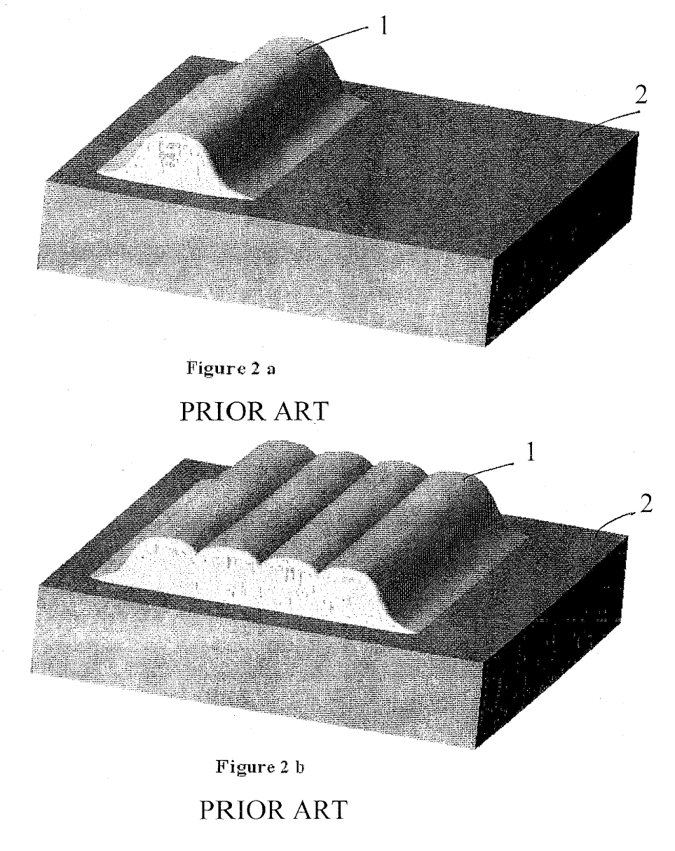

In a typical SFFF deposition, once the high energy beam is energized and the initial pool of molten metal is formed on the mandrel, either the torch or the mandrel is moved so that a row of deposited metal is formed (FIG. 2a). Then, additional rows of metal are then deposited, e.g. parallel to the initial deposit (FIG. 2b). The deposition of each of these additional rows is such that they overlap the previous row to provide good bonding between rows. Before each deposited row cools and solidifies, its shape is modified by viscous flow of the molten metal due to gravity. As illustrated in FIG. 3, this generally results in a final deposit shape (4) which is shorter and wider than the form of the original molten deposit (1).

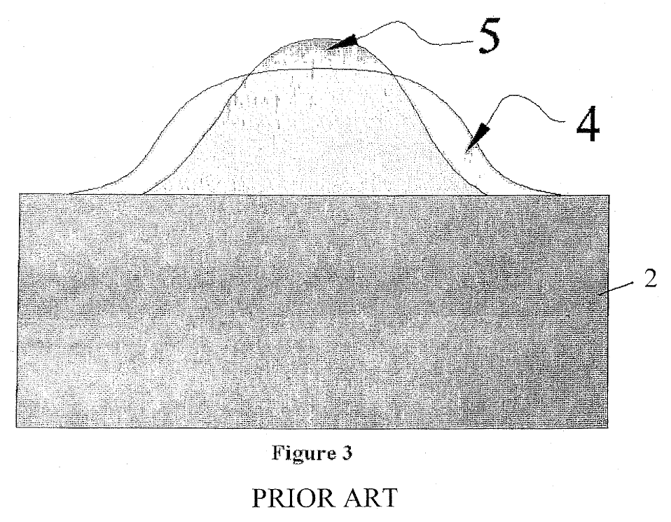

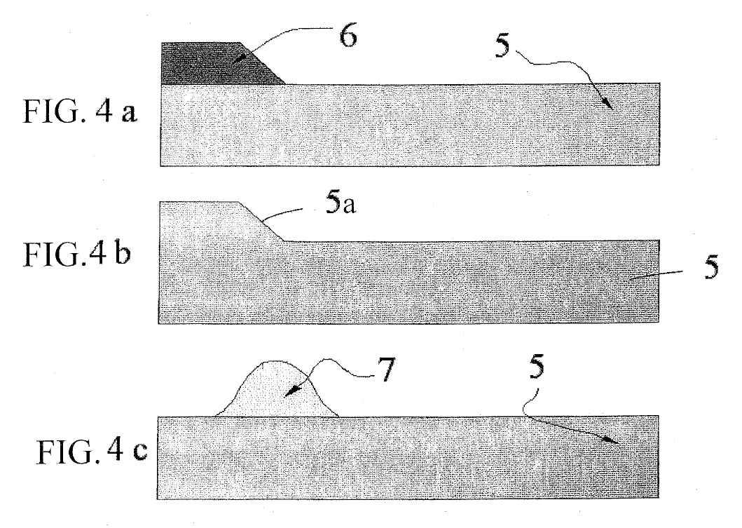

A reusable mandrel for SFFF processing as described in the instant invention is illustrated in FIGS. 4a-4c. A thermally conductive feature is provided on the top surface of a reusable mandrel (5). In one aspect of the instant invention, a thermally conductive feature is attached to the top surface of the mandrel. This attachment can be e.g. a metal plate (6) that is fastened or bolted to the mandrel so as to provide good heat conduction to the mandrel as shown in FIG. 4a. This thermally conductive feature can also be graphite or other material of good thermal conductivity that can withstand the direct application of molten metal by the SFFF process without some form of disintegration such as cracking or rapid decomposition.

Alternatively, the mandrel can be of a structure such as that shown in FIG. 4b wherein the thermally conductive feature 5a is part of a previously manufactured mandrel. In still another alternative, a thermally conductive metal feature can be a built-Lp region (7), which can be formed by depositing the desired material on the reusable mandrel (5) by the SFFF process as illustrated in FIG. 4c. The thermal conductivity of the feature preferably is equal to or higher than the thermal conductivity of the deposited metal and of the mandrel so as to ensure the predominant heat flow is from the deposited metal through the feature then to the mandrel rather than directly from the melt pool to the mandrel. A critical element of the thermally conductive feature is that it be tapered along one edge, with a slope such that when molten metal is deposited on the sloped portion, it will exhibit viscous flow downhill toward the mandrel. The degree of slope required to effect said viscous flow depends on the composition of the metal being deposited.

The mandrel itself may be formed of a metal, such as for example titanium or a titanium alloy, molybdenum, tungsten, tantalum, steel, stainless steel, Inconel, nickel, or copper; of graphite; or of a ceramic material, such as for example, boron nitride, silicon nitride, or silicon carbide. Likewise, the thermally conductive feature may be formed of any of these same materials. As described herein, certain advantages may be achieved if the thermal conductivity of the thermally conductive feature is greater than the thermal conductivity of the mandrel and/or the feedstock material. In addition, some consideration should be given to the melt temperature of the mandrel and the thermally conductive feature in relation to the melt temperature of the feedstock material, as a melt temperature lower than the melt temperature of the feedstock material may require the use of additional cooling methods.

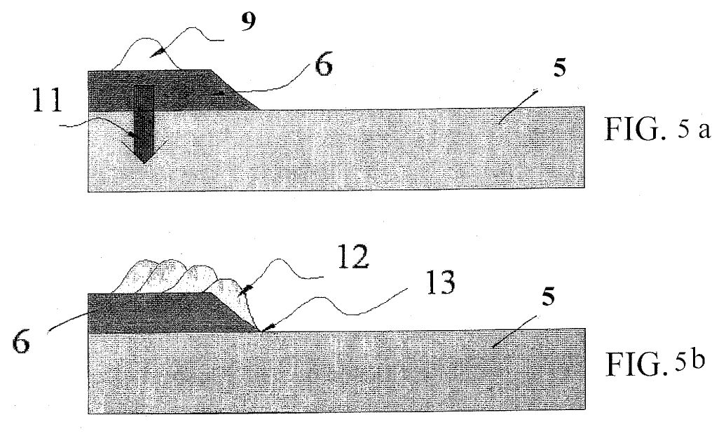

Another aspect of the present invention provides a process or method for using the mandrel described above. In the SFFF deposition utilizing the reusable mandrel described herein, the high energy beam is initially positioned over the thermally conductive feature. The metal feedstock material may be in the form of a particulate or wire material, and may be comprised of, for example, titanium or a titanium alloy, steel, Inconel, nickel, or any other material commonly used in a SFFF process. The deposit (9) may then made directly onto the thermally conductive feature (6) as shown in FIG. 5a. As the deposited metal cools and solidifies, the heat flow (11) is through the thermally conductive feature into the mandrel. A high degree of bonding between the deposited metal and the thermally conductive feature should maximize the rate of heat flow to the mandrel (5). As described above, the shape of the molten deposit broadens before it solidifies as a result of melt flow due to gravity.

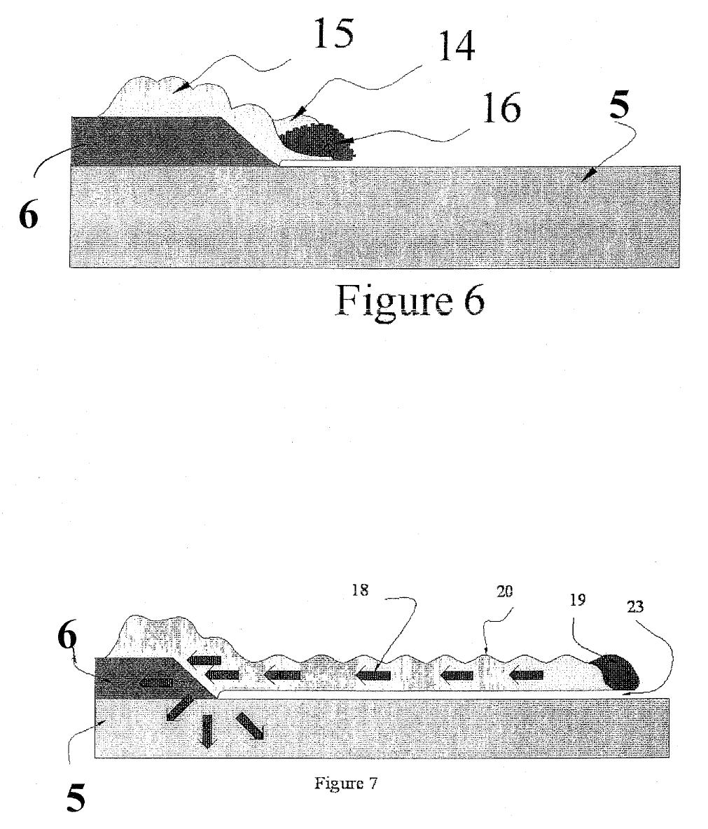

The SFFF process may be controlled by manipulating various attributes of the high energy beam, the device used to control the relative position of the high energy beam and the mandrel, and the device used to feed the feedstock material to the process. These attributes include the relative trajectory of the high energy beam in relation to the surface of the mandrel, the rate of feeding the feedstock material, and the power supplied to the high energy beam. For example, as the SFFF process continues, the high energy beam is moved along the thermally conductive feature and down the tapered edge of the thermally conductive feature. The deposition is continued in this manner until the deposited metal (12) approaches the end (13) of the tapered section of the thermally conductive feature (6) as illustrated in FIG. 5b. At this point the power to the high energy beam may be decreased so as to reduce the temperature of the melt pool. As the deposition continues to travel away from the thermally conductive feature and over the mandrel, the position of the high energy beam is controlled so that additional molten metal (14 in FIG. 6) forming successive deposits is deposited only over the previous deposit of solidified metal (15). As a result of the aforementioned viscous flow of the molten metal, the cooling metal is extended (16) over the mandrel surface (5). Since the temperature of the metal flowing over the mandrel is significantly reduced, the result is that the newly deposited metal does not bond to the substrate.

By properly manipulating the high energy beam and the feedstock material over the surface of the mandrel, the mandrel and method of the present invention can result in a desired three-dimensional shape while achieving desired mechanical properties such as, for example, density of the deposited material and microstructure properties including grain size. In addition, proper control of the process allows the mandrel to be easily separated from the resulting structure. Results may be enhanced by monitoring certain parameters (such as the temperature of the molten metal at deposition and the current temperature of previous deposits) during the SFFF process.

As illustrated in FIG. 7, the predominant heat flow (18) away from the molten metal pool (19) is provided through the solidified metal deposit (20), i.e. a lateral heat flow generally parallel to the mandrel, to the thermally conductive feature (6) and then to the mandrel (5). This lateral heat flow results in a finite gap or void plane (23) between the layer of deposited metal and the mandrel surface. As a result of this lateral heat flow, the temperature of the mandrel surface is sufficiently low in the vicinity of the melt pool to prevent bonding between the mandrel and deposit.

The heat can further be removed from the mandrel by natural cooling or forced cooling, including fluid cooling (water, air, or cryogenic fluid or gas), or by using a heat sink attached to the mandrel alone or in combination with another cooling method.

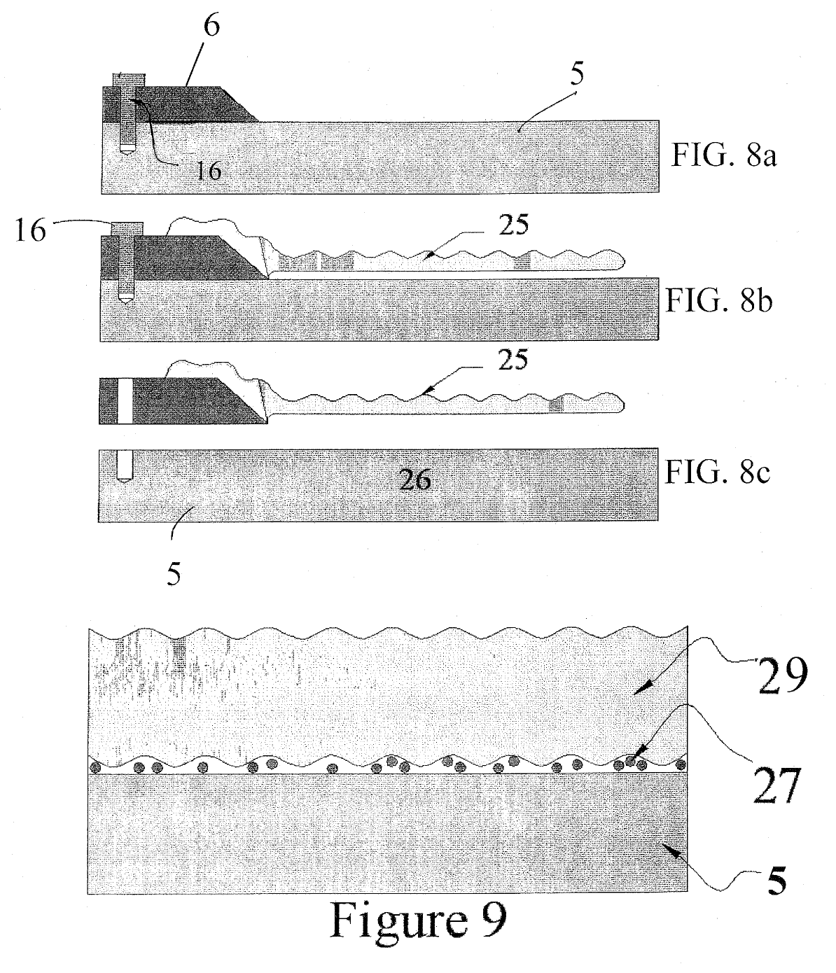

After the SFFF deposition is completed, the thermally conductive feature (6) is detached from the mandrel. In the case illustrated in FIGS. 8a and 8b this is accomplished by removing the bolts (16) which were used to attach the heat sink to the mandrel. The deposited metal (25) and thermally conductive feature (6) readily separate from the mandrel (5). The thermally conductive feature is then easily removed from the deposited shape e.g. by minimal cutting, EDM machining, laser cutting, torch cutting, or water jet cutting.

Also within the scope of the instant invention, this lack of bonding between the deposited metal and the mandrel can be enhanced or facilitated by the presence of a small amount of unmelted powder (27) of the metal being deposited, or of a metal with a melting point higher than that of the metal being deposted, or of an alternative composition such as a ceramic composition or graphite in the gap or void between the mandrel (5) and the deposited metal (29) as shown in FIG. 9.

Alternatively, a refractory coating may be used to aid in protecting of the deposits from interacting with the mandrel.

In the case wherein the high energy beam for the SFFF process is a plasma transferred arc welding torch, the thermally conductive feature and the mandrel must be electrically conductive.

The mandrel and method of the present invention may be used to form a thin, three-dimensional structure having a desired net shape (such as a shell, tube, or plate) using the SFFF process. The shape of the mandrel should be chosen to achieve the desired net shape. Similarly, the thermally conductive feature also may be formed to achieve the desired net shape. For example, the thermally conductive feature may be a shape raised above the surface of the mandrel to an amount that is within the range of 0.5-2.5 times that of a desired thickness for the three-dimensional structure.

The present invention is further illustrated by the following non-limiting examples.

### EXAMPLE 1

A mandrel for solid free form fabrication was provided by machining a ⅜″ thick plate of Ti-6Al-4V into a 6″×4″ square. A plasma transferred arc welding torch was positioned such that the high energy beam was directly over the Ti-6Al-4V mandrel. Deposition of a Ti-6Al-4V plate with dimensions of 5.5″×4″×0.1″ was then completed. When the deposited part cooled to room temperature, the deposited Ti-6Al-4V plate was welded to the Ti-6Al-4V mandrel and had to be separated by EDM machining.

### EXAMPLE 2

A mandrel for solid free form fabrication was provided by machining a ½″ thick plate of graphite into a 6″×4″ square. A plasma transferred arc welding torch was positioned such that the high energy beam was directly over the graphite mandrel. Deposition of a Ti-6Al-4V plate with dimensions of 5.5″×4″×0.1″ was then completed. When the deposited part cooled to room temperature, the deposited Ti-6Al-4V plate was bonded to the graphite mandrel and had to be separated by machining. A chemical analysis indicated that a considerable amount of carbon was present in the deposited Ti-6Al-4V.

### EXAMPLE 3

A reusable mandrel for solid free form fabrication was provided by machining a ⅜″ thick plate of Ti-6Al-4V into a 6″×4″ square. A plate of low carbon steel with dimensions of 1″ by 6″×¼″ thick with a taper on one edge was bolted to one end of the substrate. A plasma transferred arc welding torch was positioned such that the high energy beam was directly over the steel plate. Deposition of a Ti-6Al-4V plate with dimensions of 5.5″×4″×0.1″ was then completed. When the deposited part cooled to room temperature, the steel plate was unbolted and the entire deposit and steel plate were readily separated from the underlying Ti-6Al-4V mandrel without the necessity of any machining operation.

### EXAMPLE 4

Example 3 was repeated using a tungsten mandrel. There was no contamination of the Ti-6Al-4V deposit by the tungsten mandrel.

### EXAMPLE 5

Example 3 was repeated using a graphite mandrel. There was no contamination of the Ti-6Al-4V deposit by the graphite mandrel. This was repeated an additional 10 times, and the deposit readily separated from the mandrel each time with no contamination of the Ti-6Al-4V deposit by the graphite mandrel.

### EXAMPLE 6

Example 3 was repeated with an Inconel deposit on an Inconel mandrel. After cooling, the Inconel deposit and steel plate were readily separated from the underlying Inconel mandrel.

It should be emphasized that the above-described embodiments of the present device and process, particularly, and “preferred” embodiments, are merely possible examples of implementations and merely set forth for a clear understanding of the principles of the invention. Many different embodiments of the invention described herein may be designed and/or fabricated without departing from the spirit and scope of the invention. All these and other such modifications and variations are intended to be included herein within the scope of this invention and protected by the following claims. Therefore the scope of the invention is not intended to be limited except as indicated in the appended claims.

1. A reusable mandrel for use in connection with a solid free form fabrication process to form a structure by depositing a feedstock material onto the mandrel using a high energy beam, the mandrel having a thermally conductive feature on a top surface of the mandrel for providing a path for directing a heat flow away from the feedstock material.

2. The mandrel of claim 1, wherein the thermally conductive feature prevent the top surface of the mandrel from bonding with or contaminating the feedstock material, whereby the mandrel can be readily detached from the structure so as to be reusable.

3. The mandrel of claim 1, wherein the thermally conductive feature has a tapered edge.

4. The mandrel of claim 1, wherein the thermally conductive feature comprises a metal plate that is attached to the top surface of the mandrel.

5. The mandrel of claim 4, wherein the metal plate is formed using a material selected from the group consisting of steel, stainless steel, molybdenum, tungsten, tantalum, Inconel, nickel, copper, titanium, a titanium alloy, graphite, and a ceramic.

6. The mandrel of claim 4, wherein the metal plate has a thermal conductivity that is greater than a thermal conductivity of the mandrel.

7. The mandrel of claim 4, wherein the mandrel is electrically conductive.

8. The mandrel of claim 4 wherein the metal plate has a thermal conductivity that is higher than a thermal conductivity of the feedstock material.

9. The mandrel of claim 1, wherein the thermally conductive feature is integrally formed as a part of the mandrel.

10. The mandrel of claim 1, wherein the thermally conductive feature is deposited on the mandrel by the solid free form fabrication process.

11. The mandrel of claim 1, wherein the mandrel is formed of a material or materials selected from the group consisting of: titanium, a titanium alloy, molybdenum, tungsten, tantalum, steel, stainless steel, Inconel, nickel and copper.

12. The mandrel of claim 1, wherein the mandrel is formed of graphite.

13. The mandrel of claim 1, wherein the mandrel is formed of a ceramic material.

14. The mandrel of claim 13, wherein the ceramic material is selected from the group consisting of boron nitride, silicon nitride, silicon carbide, and titanium diboride, and the energy source for the SFFF process is a laser or a welding torch including E-beam, TIG or MIG.

15. A process for forming a structure by solid free form fabrication process comprising providing a reusable mandrel as claimed in claim 1, and initiating depositing of the feedstock material onto the thermally conductive feature to create a first deposit.

16. The process of claim 15, wherein the high energy beam is a laser or a welding torch including E-beam, plasma transferred arc, TIG, and MIG.

17. The process of claim 15, wherein the feedstock material is selected from the group consisting of: titanium, a titanium alloy, steel, Inconel and nickel.

18. The process of claim 15, wherein the solid free form fabrication process is carried out with a thin layer of discrete unmelted particles on the top surface of the mandrel.

19. The process of claim 15, wherein a plurality of successive deposits are created by depositing the feedstock material such that it is in direct contact essentially only with a previous deposit.

20. A method of producing thin, three-dimensional shapes comprising the steps of:
providing a high energy beam capable of localized rapid heating;
providing a first device capable of controlling movement in three dimensions;
providing a second device capable of feeding a feedstock material to the high energy beam;
providing a mandrel having a desired geometry;
moving the feedstock material into the high energy beam and heating up the feedstock material to create a pool of molten metal;
scanning the high energy beam over a surface of the mandrel to form a plurality of deposits of the pool of molten metal on the surface of the mandrel;
controlling various attributes of the high energy beam and the second device to cause the plurality of deposits to bond to other of said plurality of deposits;
monitoring a set of parameters of each of said plurality of deposits in order to form a three-dimensional structure having a desired net shape and mechanical properties; and
separating the three-dimensional structure from the mandrel.

21. The method of claim 20, wherein the feedstock material is in the form of a wire.

22. The method of claim 20, wherein the feedstock material is in the form of a powder.

23. The method of claim 20, wherein the high energy beam is a laser or a welding torch including E-beam, plasma transferred arc, TIG, and MIG.

24. The method of claim 20, wherein the mandrel is formed of a solid material having a melt temperature equal to or higher than a melt temperature of the feedstock material.

25. The method of claim 20, wherein the mandrel is reused.

26. The method of claim 20, wherein the desired net shape of the three-dimensional structure is a shell, a tube, or a plate.

27. The method of claim 20, wherein the various attributes include a trajectory of the high energy beam relative to the surface of the mandrel, a rate of feeding the feedstock material, and an amount of power supplied to the high energy beam.

28. The method of claim 20, wherein the mandrel has a melt temperature lower than a melt temperature of the feedstock material, and including cooling he mandrel to prevent the surface of the mandrel from exceeding the melt temperature of the mandrel during the step of scanning the high energy beam.

29. The method of claim 28, wherein the mandrel is cooled by natural or forced cooling.

30. The method of claim 20, including providing the mandrel with a refractory coating which protects the metal from interacting with said mandrel during the step of scanning the high energy beam.

31 The method of claim 20, including providing the mandrel with a raised shape on its top surface.

32. The method of claim 31, wherein the raised shape is a built up region on the mandrel top surface.

33. The method of claim 31, wherein the raised shape is a thermally conductive plate fastened to the mandrel.

34. The method of claim 31, wherein the raised shape is raised above the surface of the mandrel to an amount that is 0.5-2.5 times that of a desired thickness for the three-dimensional structure being produced.

35. The mandrel of claim 1, wherein the composition of the mandrel is an electrically conductive ceramic including titanium diboride when the energy source for the SFFF process is a plasma transferred arc welding torch.

36. The process of claim 18, wherein the unmelted powder is the same composition as the deposit.

37. The process of claim 18, wherein the unmelted powder is a ceramic including silicon nitride, boron nitride, aluminum oxide, or other ceramic that does not melt at the deposition temperature.

38. The process of claim 18, wherein the unmelted powder is carbon based including graphite.

39. The process of claim 15, wherein the deposition is carried out with a thin layer of discrete unmelted ceramic or carbon based particles on the mandrel surface.
